(19) United States
(12) Patent Application Publication
(10) Pub. No.: US 2002/0082870 A1
(43) Pub. Date: Jun. 27, 2002

(54) System and method for processing patient medical information

(76) Inventors: Mark Penny, Salem, MA (US); Paul Gilman, Gloucester, MA (US); John E. Auer, Ipswich, MA (US); Rand Monteleone, Acton, MA (US)

Correspondence Address: Siemens Corporation, Intellectual Property Department, 186 Wood Avenue South, Iselin, NJ, 08830, US

(21) Appl. No.: 09/992,991

(22) Filed: Nov. 19, 2001

Related U.S. Application Data
(60) Provisional application No. 60/252,111, filed on Nov. 20, 2000.

(51) Int. Cl. G06F 17/60

(52) U.S. Cl. 705/3

(57) ABSTRACT

An internet compatible system and method are presented for displaying medical information derived from a plurality of sources. Medical parameters associated with a patient including patient laboratory results are collected via a communication network, collated and stored in a relational database. The database is then searched for specific laboratory test results based on one or more of (a) a text string identifying a portion of a lab test name, (b) a patient identifier, and (c) a date. Those test results meeting the specified search criteria are then displayed to a user in a desired order. An attribute is allocated to distinguish newly acquired or non-reviewed laboratory results.

### CROSS REFERENCE TO RELATED APPLICATION

This application claims the benefit of provisional U.S. application, U.S. Ser. No. 60/252,111 filed Nov. 20, 2000.

### FIELD OF THE INVENTION

This invention is related to the processing and displaying of medical information, and more particularly to processing and displaying of patient medical data including laboratory test results in a network environment.

### BACKGROUND OF THE INVENTION

In hospitals and other health care environments, it is often necessary or desirable to collect and display a variety of medical data associated with a patient. Such information may include laboratory test results, care unit data, diagnosis and treatment procedures, ventilator information, attending physician or health care provider, and calendar information associated with a given patient. Presently, such information is often provided via a chart attached to a patient's bedside or at an attendant's station. However, such physical charts are cumbersome to view, and often do not include the most up-to-date medical information associated with the patient, such as laboratory test results. This problem is exacerbated due to the fact that such medical data arrives from multiple sources and at various times. Furthermore, present charts are not adapted to enable a care giver to easily access, view, or determine the results of multiple medical tests or other data associated with the patient. Consequently, a need exists for a faster, more effective and user friendly means for accessing, correlating and displaying patient medical information derived from a plurality of sources.

### SUMMARY OF THE INVENTION

An internet compatible system and method are presented for displaying medical information derived from a plurality of sources. Medical parameters associated with a patient including patient laboratory results are collected via a communication network, collated and stored in a relational database. The database is then searched for specific laboratory test results based on one or more of (a) a text string identifying a portion of a lab test name, (b) a patient identifier, and (c) a date. Those test results meeting the specified search criteria are then displayed to a user. The communication network acquires the laboratory results from a plurality of sources using various network protocols; such protocols include ASTM and HL7 protocols for interfacing with local and wide area networks and peripheral medical devices.

The results may be displayed to the user in a desired order, including ordering the results by date, patient name or test result type. An attribute is allocated to distinguish newly acquired or non-reviewed laboratory test results from older laboratory tests that a user has previously acknowledged. Additional attributes are allocated to alert the user to particular characteristics associated with the laboratory results, such as whether a lab or particular lab test result is within normal range.

In another aspect, the system of the present invention continuously acquires additional medical information associated with patients for display in a composite window. The medical information displayed is based on patient data for those patients presently associated with a particular care unit, such as an intensive care unit or emergency room unit. This is advantageous for automatically providing the most current, updated patient information associated with a given care unit; such information including patient identifier, ventilator information, diagnosis information, procedure information, caregiver responsibility, and laboratory test results indicators.

### BRIEF DESCRIPTION OF THE DRAWING

In the drawing:

FIG. 1 is a block diagram of a communication network with various devices, according to the principles of the invention.

FIG. 2 represents a flow diagram of a system according to the present invention.

FIG. 3 shows an exemplary way of how laboratory test results data are displayed according to the present invention.

FIG. 4 shows an exemplary way of how additional patient information associated with a given care unit are displayed according to the present invention.

FIG. 5 represents a flow diagram of a system displaying patient medical information on a care unit basis according to the present invention.

FIG. 6 is a block diagram of a server having functionality in accordance with the present invention.

### DETAILED DESCRIPTION

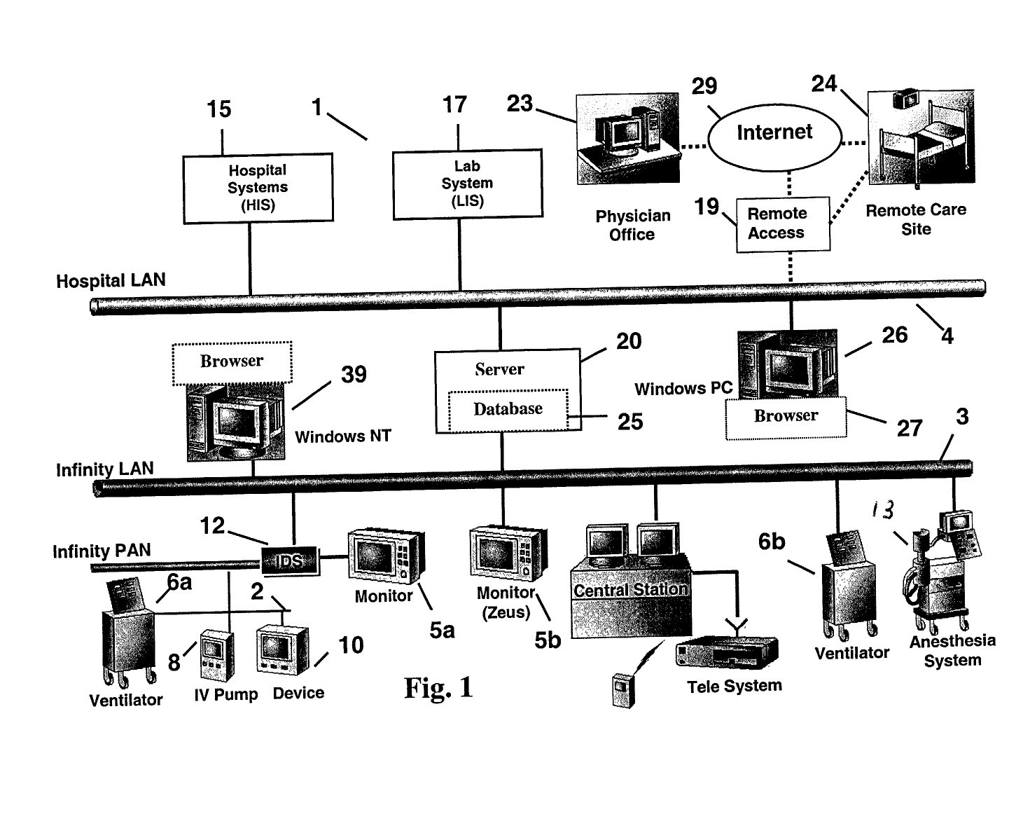

FIG. 1 is an exemplary block diagram of a communication network according to the principles of the present invention. As shown in FIG. 1, communication network I is represented by an IP (Internet Protocol) compatible network with a hierarchy of local area and wide area networks interconnected together. It is to be noted that although the present exemplary hospital or medical network is an IP compatible network, other types of networks such as, but not limited to optical or wireless networks, using other computing protocols such as, but not limited to, for example, X.25, frame relay, IBM SNA etc., may also be used, as one skilled in the art can readily appreciate. In addition, although the exemplary network described is a hierarchical network, this is not required by the present invention. Any type of network architecture that provides communication connectivity among the devices on the network may be used.

As shown on FIG. 1, the first level of the exemplary hierarchical network 1 comprises a Medical Interface Bus (MIB) 2. A MIB is a well-known medical industry standard for locally connecting medical devices together. As shown in FIG. 1, MIB 2 is typically used to interconnect medical devices in a patient's room to administer care to a particular patient and to monitor the particular patient. Various medical devices may be connected via MIB 2; examples shown in FIG. I comprise a ventilator 6a, IV (Intravenous) Pump 8 or other medical equipment 10.

MIB 2 is typically connected to a second level LAN network 3 through an Interface Docking Station (IDS) device 12, for interfacing to Ethernet-compatible LAN network 3. The higher-level LAN 3 may be for example, an Infinity LAN, marketed by Siemens Medical System. This higher-level LAN 3 is typically, though not necessarily, used by a particular department within a hospital, such as an intensive care department or surgery department, etc., depending on the size of the organizations.

Although not shown in FIG. 1, more than one MIB may be connected to the second level LAN 3, so that more than one patient may be monitored or given care through LAN 3. In addition, medical devices may be connected directly to higher-level LAN 3. For example, as shown in FIG. 1, a ventilator 6b and an anesthesia system 13 are connected directly to LAN 3, without the need to go through a MIB.

Furthermore, LAN 3 may be interconnected to a Hospital LAN backbone 4 which also is Ethernet compatible. This backbone network 4 provides communication connectivity between various departments within a hospital or medical organization; for example, connecting hospital administrative systems 15 together with laboratory systems 17. In addition, the Hospital LAN 4 has a remote access gateway 19 which provides remote, secured access from, for example, a remote doctor's office 23 or a remote care site 24, to the various systems and devices on network 1, through for example, Internet 29. Alternatively, a remote site may also access the remote access gateway 19 directly through, for example, a dial-up telephone port, ADSL, or other types of private connection. Remote access gateway 19 may also be part of server 20, to be described below, instead of standing alone, as well know in the art.

According to the principles of the present invention, a central server 20 resides on LAN 3 for gathering and processing data from the peripheral medical devices or facilities coupled to LAN 3 or hospital LAN 4, including lab results supplied via lab system 17 connected through an HL7 interface, for example. Additional medical parameter data including additional lab results acquired from any number of medical devices such as those shown in FIG. 1 may be obtained at server 20 using ASTM messaging, for example. The acquired medical parameters associated with a given patient, including laboratory test results, are acquired from the medical devices on network 1 for display and control. One skilled in the art can readily recognize that server 20 may reside at any level of the hierarchy of network 1, since all the different levels of LANs (e.g., 3, or 4), as well as remote sites in FIG. 1 are interconnected together. An example of server 20, is a Prometheus server, marketed by Siemens Medical System. The server may be hosted, for example, by a computer system that is capable of running Microsoft NT operating system.

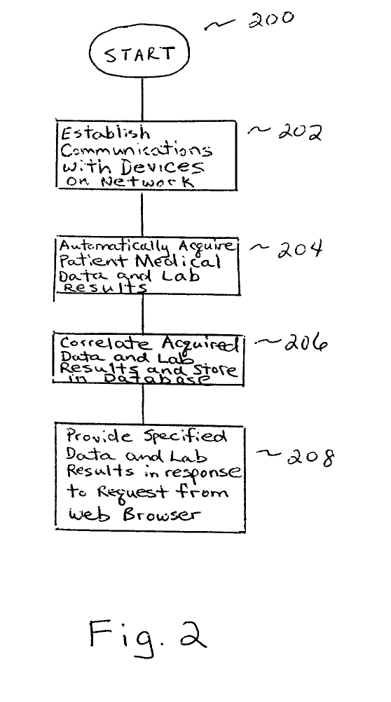

FIG. 2 shows in flow chart form, functions that may be performed by server 20 in accordance with the present invention. Server 20 first establishes communications with devices on the network as shown in step 202. This is done, for example, by using IP protocol and the known IP device address for each device on the network 1, in conjunction with any higher application-layer protocols, as well known in the art.

Once communications are established between server 20 and the other devices, server 20 starts to acquire parameters that are being monitored and settings selected for the various devices, including lab results. As previously mentioned, such lab results may be obtained through an HL7 interface with LIS 17, or via ASTM or MIB point of care (POC) medical devices depicted in FIG. 1.

Medical data and lab results may be continuously or periodically acquired and correlated with a given patient for storage in relational data base 25 within server 20.

Data base 25 may be of the type used for storing relational data such as the Microsoft SQL server.

In one aspect of the present invention, a user may use a Microsoft Windows compatible PC 26 or Windows NT compatible PC 39 as shown in FIG. 1, or any other computers capable of running a menu generating program such as a web browser program (e.g., Microsoft Internet Explorer or Netscape Navigator, etc.) to view medical parameters and lab results information associated with a given patient. That is, a user may use a web browser on any computer, as long as a communication connection can be made to server 20, to make request and view information acquired and stored in data base 25. This is advantageous, since a doctor may for example, gain access to lab test results from, for example, a remote physician's office 23, without having to access a dedicated terminal. Of course, a user can simply use a keyboard and/or a mouse or any other user interface devices to enter a user selection or request on a user computer, as is known in the art.

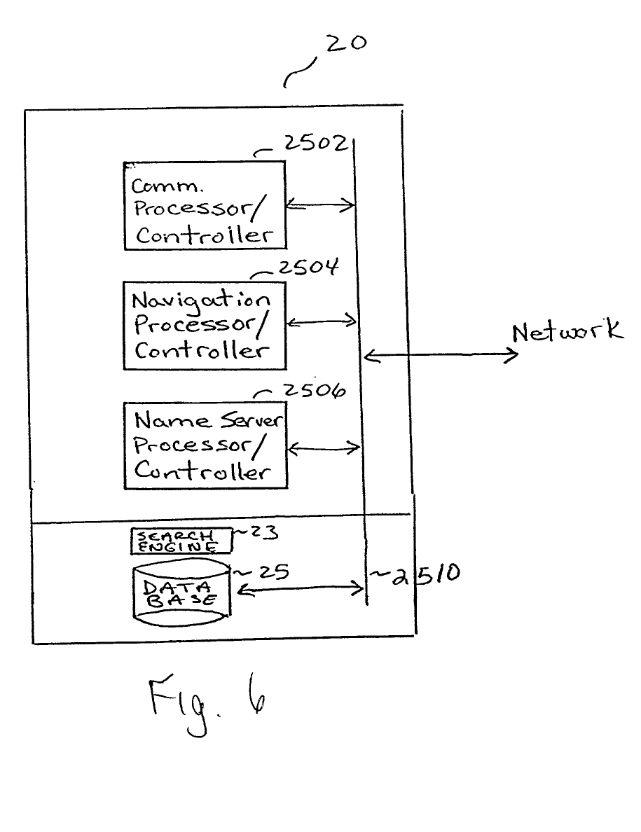

Server 20 is therefore capable of collating and formatting medical data to be compatible with, for example, HTML (HyperText Mark-up Language) programming language for displaying data on a web browser. The server is also responsive to, for example, HTTP (HyperText Transfer Protocol) commands originated from a user's web browser for making a request. FIG. 6 shows a block diagram of an exemplary embodiment of the server 20 which operates to manage, collate, search and update the data base 25 containing patient medical information. Program elements or processors operative to carry out instructions for performing the various functions described herein include communications processing module 2502 that acquires the patient data including the monitored parameters allocated to a given patient from the network and collates the information for storage in data base 25. Navigation collation processor 2504 operates in conjunction with the web browser and display generator software to collate and prioritize parameters for display to the user while navigating through various applications -selected by a user through the -user interface. Name server processor 2506 associates unique identifiers (Ids) with each node connected to the system network and with each patient in the system in order to track and update patient information throughout the system. Input/output data and control signals are used to communicate between the various processors as well as to interface with the data base 25 and search engine 23 and with the network via communication line 2510.

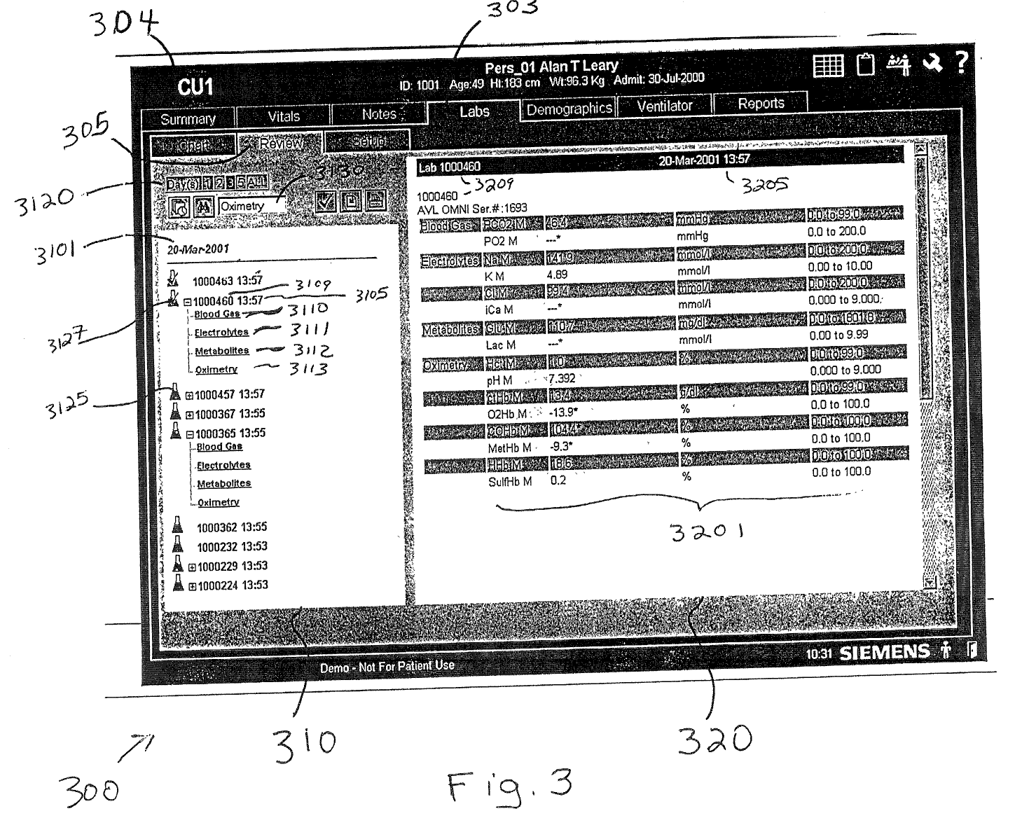

FIG. 3 shows an example of how medical parameters including lab test results may be retrieved and displayed on a web browser of a user computer 26, according to the present invention. As shown, a display window 300 comprising a navigator panel portion 310 and a results portion 320 is displayed in response to a user request for access to particular medical parameter data associated with a given patient. This is accomplished, for example, by specifying the name of a particular patient or bed on the network (e.g., CUI 304, Leary or Person 01) and by selecting on LABS tab 303. An exemplary review display 300 is shown in FIG. 3 when the user selects Review icon 305. The navigator panel display portion 310 displays the results of a search of the data base 25, including the date field 3101 and time field 3105 that a lab message was received, the lab result number 3109, and a note icon displayable in response to a user-entered lab annotation. Each of the lab messages 3109 is shown in navigator panel portion 310 in date and time sequence order.

The system operates to group each of the test results 3110, 3111, 3112, 3113 associated with a given lab 3109. As shown in FIG. 3, each of the test results corresponds to a particular type of test, such as Blood Gas, Electrolytes, Metabolites and Oximetry, for example. User selection of a given lab 3109 provides a direct link or association to each of the corresponding lab test results 3110-3113 for display in the results display portion 320. Parameter data 3201 associated with the corresponding lab test results are displayed in panel 320 in response to user selection, thereby providing additional detailed patient medical information for each specific lab test. A date/time indicator 3205 and lab indicator 3209 indicating the selected lab 3109 are also provided on display results portion 320.

The system of the present invention further operates to permit a user to select or modify the number of calendar days for which the selected test results are to be displayed. A user selectable entry pad 3120 enables a user to select a predetermined time period over which to search and retrieve the parameter data for display in window 300. In a particular embodiment, user selection control is provided in day increments of 1, 2, 3, 5 or ALL. For example, user selection of 1 Day for entry pad 3120 would result in the search engine retrieving and displaying only those most recent test results (i.e. those with time entries within 1 day of the present time) that also meet all other search criteria. Conversely, user selection of ALL Day would result in the search engine retrieving and displaying all test results that meet all other search criteria without regard to date/time. The results data display 320 may be listed in chronological order. Alternatively, the results may also be listed in search order, resulting from a given search operation as discussed below. Those test results meeting the search criteria may also be listed in chronological order.

Navigator panel portion 310 further includes a search field 3130 enabling a user to enter a text string portion corresponding to a type of lab test. The search engine compares the text string with a list of all lab test types and produces a listing of all the labs that correspond to that test type(s) associated with the text string for a given patient with respect to the day selection control 3130. This provides the user with even more efficient and customizable display of medical test results data.

A display indicator 3125 or flag is associated with each of the corresponding labs 3109 that have not been reviewed or selected for review. This enables a user to quickly ascertain potentially new lab results. Upon user selection and review of the previously unreviewed lab, an indicator 3127 is provided on display portion 310 to indicate the selected lab has been reviewed.

The system further provides additional information indicative of whether a lab result is within normal range. For example, flag 3125 may include an attribute such as a first color attribute (e.g. green) when all lab results corresponding to that lab message are within normal range, and a second color attribute (e.g. red) if any one of the results lies outside the normal range. Display 300 provides further indicia for each of the lab test results 31 10-3113 indicative of which results lie within normal range. In a particular embodiment, the text associated with each lab test result may have an additional first attribute (e.g. colored black) for normal range and second attribute (e.g. colored red) for abnormal range. Such indicia facilitate quick and easy identification of potential problems associated with the lab results.

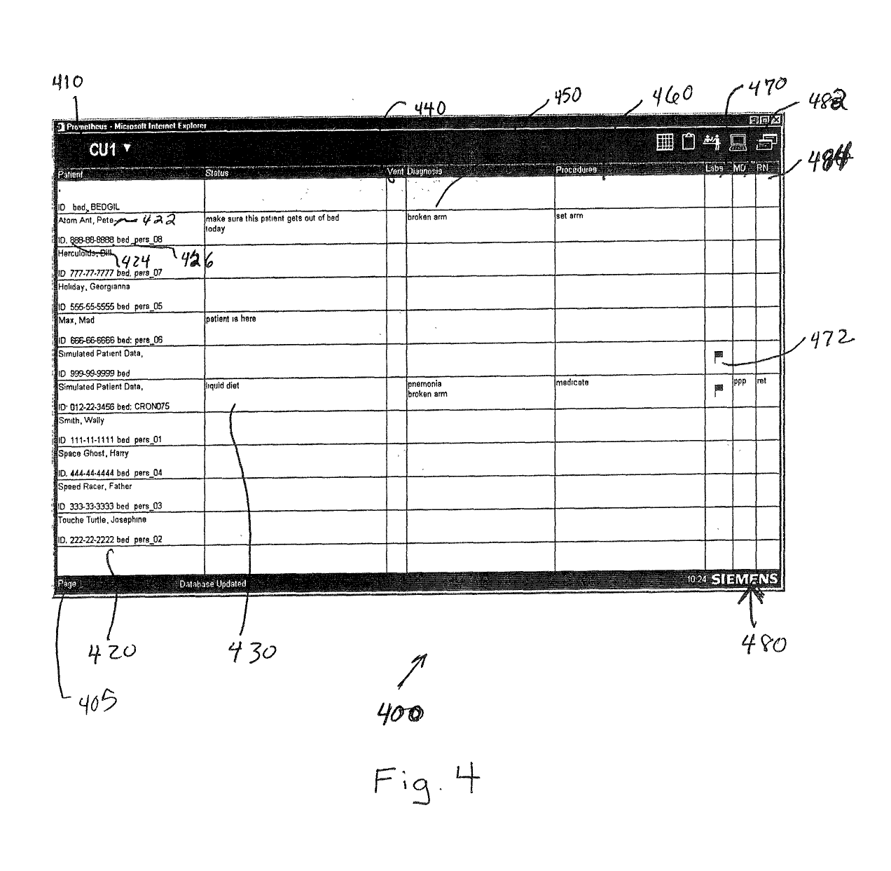

FIG. 4 illustrates a component display 400 within the web enabled clinical information system of the present invention for presenting summary information associated with patients contained within the data base meeting the display criteria. Display 400 comprises a spreadsheet style multi-patient data presentation combining electronically acquired information from the interfaced peripheral devices attached to the network, including patient monitors, ventilators, laboratory analysis systems, as well as manually entered information, for example. Display 400 operates to provide a customizable electronic representation of chart data associated with a patient or patients. This is advantageous in part because it eliminates the manual operation associated with entering and maintaining patient information on a physical chart or charts, as well as minimizing problems concerning access to the most recent information associated with a given patient.

For example, a patient admitted into a hospital may move between different care units during his stay (e.g. from emergency room (ER) to intensive care unit (ICU)). Through the various nodes on the network LAN (e.g. hospital intranet) each associated with a given care unit and bed number, network connectivity with the medical devices associated with a patient enables automatic tracking of the patient within the network. In this manner patient information may be obtained for an entire care unit.

Display 400 may be customized in response to a user request by selection of the desired data fields and columns as described below. In an exemplary embodiment, Display 400 comprises various data fields such as care unit field 410, patient field 420, status 430, ventilator 440, diagnosis 450, procedure 460, lab results 470 and attendant area 480. A user may request access to patient information associated with a particular care unit such as an Intensive Care Unit 1 (CU1) by selecting the desired care unit 410 from a pull down list or menu selection of care units. The search engine would then retrieve from the relational data base patient information associated with the selected care unit. The care unit field thus enables patients and patient information to be organized by user-selectable display criteria such as care unit, care-giver or monitoring unit, for example. When the patient list exceeds the viewable page allocation, a page indicator 405 displays the number of pages in addition to the current page and provides a hyper link to the other page numbers.

Patient field 420 provides a display of patient information including patient name 422, patient identifier (ID) 424 and patient bed number 426. The patient field 420 comprises embedded link information such that user selection of a particular patient field (via a mouse click or light pen selection, for example) provides a web-enabled screen display specific to the patient selected. Status field 430 provides a free text field into which a user or operator can enter textual information. This may be accomplished by data entry through a keyboard, light pen or other manual input means. Ventilator field 440 displays the current mode of ventilation associated with a given patient as well as the number of days that the patient has been continuously ventilated. The ventilator field values and parameter settings may be automatically acquired from ventilator units connected via the network or may be entered by a user. Diagnosis field 450 operates to display the most recent primary and secondary diagnoses associated with each patient within the selected care unit, while procedure field 460 displays the most recent stored medical procedures for each patient.

Lab results field 470 provides an indication of whether any lab results have been collected by the system for a particular patient and allocates an attribute to distinguish newly acquired lab results that have not yet been reviewed by a user. One exemplary attribute may be display color. For example, when new laboratory results are electronically acquired from the system, a colored (or multi-colored) indicator is displayed on the web browser so that the user is able to determine that new information is now available for review. Additional indicators (for example, indicator shape) may be coded on the web browser to denote the relationship of a specific value of a lab result in comparison to a normal patient data range for that result according to the analysis system transmitting such results.

For example, in a particular embodiment, the appearance of a “flag” indicator 472 indicates that the results of a particular lab have not been reviewed by a health care provider such as the attending physician or nurse. As previously discussed, the flag may have a particular color attribute, for example green, to indicate that the lab results system has indicated the results are within normal patient range. A different color attribute, for example red, may be used to indicate when results are outside the normal patient range. The lab results may also be hyper-linked to the lab results display discussed herein to enable a user to view the particular result values associated with a particular lab for a given patient. Attendant area 480 comprises physician (MD) field 482 and nurse (RN) field 484 operative to display information indicative of the respective physician and nurse presently assigned to the patient within the system.

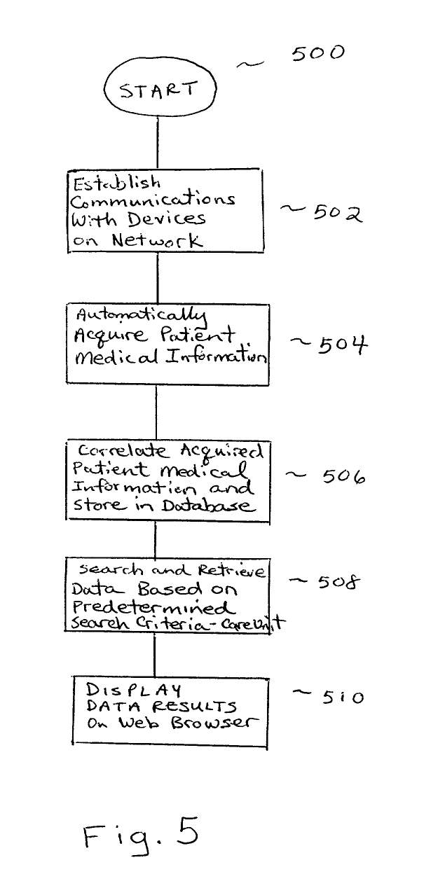

In accordance with an aspect of the present invention, display window 400 provides for the acquisition and display of additional information together with lab test results within a composite window, thereby providing an automatically updated electronic summary of patients meeting predetermined search criteria. A flow chart illustrating the high level system functions is shown in FIG. 5. As shown, upon establishing communications with the various devices and nodes on the network in step 502, the system automatically acquires patient medical information via the nodes in step 504. The information obtained via the network is collated in step 506, and stored in a database. A menu generator including a web browser displays a window containing patient medical data- meeting the predetermined search criteria, such as care unit as shown in steps 508, 510.

It is to be understood that the embodiments and variations shown and described herein are for illustrations only and that various modifications may be implemented by those skilled in the art without departing from the scope of the invention.

What is claimed is:

1. In a network compatible system for displaying medical information derived from a plurality of sources, apparatus comprising:
a communication processor for acquiring medical parameters associated with a patient including patient laboratory results;
a collation processor for collating acquired medical parameters for storage in a database; and
a device for searching said database of acquired medical parameters to find specific laboratory test results based on one or more of (a) a text string identifying a portion of a lab test name, (b) a patient identifier, and (c) a date, for display in a desired order.

2. The system of claim 1, wherein said network is at least one of an internet or intra-net compatible network.

3. The system of claim 1, wherein said collation processor orders said acquired patient laboratory results by criteria including at least one of (a) test type, (b) date, and (c) patient.

4. The system of claim 1, wherein said searching is based on additional criteria including at least one of (a) patient name, (b) caregiver identifier, (c) text identifying a diagnosis, and (d) text identifying a procedure.

5. The system of claim 1, wherein said communications processor acquires said test results from said plurality of sources using network protocols including one or more of (a) ASTM and (b) HL7.

6. The system of claim 1, wherein said communication processor continuously acquires said results from one or more of (a) a hospital intranet, and (b) a patient monitoring system.

7. The system of claim 1, wherein said system acquires and displays other information together with said test results in a composite display window, said other information including one or more of ventilator status, (b) diagnosis information, (c) care unit identifier, (d) procedure, (e) caregiver indicator, and (f) laboratory test results indicator.

8. The system of claim 1, further comprising a menu generator for generating a window for displaying said specific test results.

9. The system of claim 8, wherein said menu generator comprises an internet browser.

10. The system of claim 1, wherein said collation processor allocates
an attribute for distinguishing unreviewed test results.

11. The system of claim 10, wherein said attribute is a predetermined color.

12. The system of claim 1, wherein said collation processor allocates an attribute for identifying test results that are outside a predetermined range level.

13. The system of claim 12, wherein said attribute is a predetermined color.

14. An internet compatible method for displaying medical information derived from a plurality of sources, comprising steps of:
acquiring medical parameters associated with a patient including patient laboratory results;
collating said acquired medical parameters for storage in a database; and
searching said database of acquired medical parameters to find specific laboratory test results based on one or more of (a) a text string identifying a portion of a lab test name, (b) a patient identifier, and (c) a date, for display in a desired order.

15. The method of claim 14, further comprising the step of generating a window for displaying said laboratory test results.

16. The method of claim 14, further comprising the step of allocating
an attribute for distinguishing unreviewed test results.

17. The method of claim 14, further comprising the step of allocating
an attribute for identifying test results that are outside a predetermined range level.
